(19) United States
(12) Patent Application Publication
(10) Pub. No.: US 2020/0201988 A1
(43) Pub. Date: Jun. 25, 2020

(54) IoT DEVICE MANAGED BASED ON BLOCK CHAIN, SYSTEM AND METHOD THEREOF

(71) Applicant: Markany Inc., Seoul (KR)

(72) Inventors: Kyung Jun Park, Seoul (KR); Dong Hwan Shin, Seoul (KR); Chang Won Kim, Seoul (KR)

(21) Appl. No.: 16/687,036

(22) Filed: Nov. 18, 2019

(30) Foreign Application Priority Data
Dec. 19, 2018 (KR) 10-2018-0164969

(51) Int. Cl. G06F 21/55; H04L 9/06; G06F 21/57

(52) U.S. Cl. CPC G06F 21/552; G06F 21/572; H04L 9/0637

(57) ABSTRACT

The present invention relates to an IoT device managed based on a blockchain, and system and method thereof. A method for managing information of an IoT device performed by a client according to the present invention may comprise: transmitting a request for user registration to the IoT device; receiving device information including identification information of the IoT device from the IoT device; retrieving the received device information in a blockchain of a blockchain system to receive search result information associated with the device information recorded as a transaction in the blockchain from the blockchain system; and verifying whether the IoT device is a device registered as a validly usable device based on the received search result information.

### STATEMENT REGARDING GOVERNMENT SPONSORED RESEARCH

This work was partly supported by Institute of Information & communications Technology Planning & Evaluation (IITP) grant funded by the Korea government (MSIT) [No. 2018-0-01389, Developing Secure Bootstrapping for IoT Device with Restricted User Interfaces].

### CROSS-REFERENCE TO RELATED APPLICATIONS

This application claims priority to Korean Patent Application No. 10-2018-0164969 filed December. 19, 2018 titled IoT DEVICE MANAGED BASED ON BLOCK CHAIN, SYSTEM AND METHOD THEREOF, the disclosures of which are hereby incorporated by reference in their entirety.

### TECHNICAL FIELD

The present invention relates to an IoT device managed based on a blockchain, and system and method thereof.

### BACKGROUND

As the Internet of Things where various devices and objects are connected to each other through a network or the like expands, various Internet of Things (IoT) devices are released and used. As devices previously operated by a user manually or controlled and managed by their own operating system without a connection to a network are operated as IoT devices connected to a network, the user can control the devices more conveniently, and it is now possible to provide a variety of new services using information obtained from each IoT device.

However, as IoT devices are connected to each other through a network along with expansion of the Internet of Things, the risk of information loss, forgery or illegal operation of the IoT devices by illegal hacking of the devices or the like has increased.

Conventionally, a security maintenance method is used in which a device is assigned an ID and a password for access to and management of the device and the central server manages access to the device by a user or a service provider. However, the method has a problem of being vulnerable to hacking. In addition, IDs and passwords of many IoT devices are not properly managed, and devices are often distributed without changing their initial IDs and passwords (for example, “admin” and “1234”) set by device manufacturers and used after purchase with the IDs and passwords unchanged.

This can lead to problems that the management authority for a IoT device is hacked such that the device is illegally operated by an outside intruder tempering with the device's firmware, that an intruder takes over the control of the device to illicitly use information related to the device, and that the device can be used as a bot to attack systems connected to it.

### SUMMARY

In this light, the IoT device managed based on a blockchain and the system and the method thereof according to the present invention have objects of solving the above-mentioned problems of the conventional technology and enhancing security of maintenance and management of IoT devices and services related thereto.

In order to achieve the objects, a method for managing information of an IoT device performed by a client according to the present invention may comprise: transmitting a request for user registration to the IoT device; receiving device information including identification information of the IoT device from the IoT device; retrieving the received device information in a blockchain of a blockchain system to receive search result information associated with the device information recorded as a transaction in the blockchain from the blockchain system; and verifying whether the IoT device is a device registered as a validly usable device based on the received search result information.

In an example, the method may further comprise transmitting, by the client, a request to record user registration information as a transaction in the blockchain of the blockchain system to the blockchain system, when the IoT device is verified as a device registered as a validly usable device in the verification step.

In an example, the device information may further comprise firmware information of the IoT device, and the user registration information may comprise at least one of identification information of the IoT device, user information, and firmware information of the IoT device.

In an example, the method may further comprise transmitting, by the client, a request to record cancellation of user registration as a transaction in the blockchain of the blockchain system to the blockchain system.

A method for managing information of an IoT device performed by a server according to another example may comprise: receiving device information including identification information of the IoT device from the IoT device responding to a request for service use registration; retrieving the received device information in a blockchain of a blockchain system to receive search result information associated with the device information recorded as a transaction in the blockchain from the blockchain system; and verifying whether the IoT device is a device registered as a validly usable device based on the received search result information.

In an example, the method may further comprise transmitting, by the server, a request to record service use registration information as a transaction in the blockchain of the blockchain system to the blockchain system, when the IoT device is verified as a device registered as a validly usable device.

In an example, the device information may further comprise firmware information of the IoT device, and the service use registration information may comprise at least one of a code specifying a service, identification information of the IoT device, user information, and firmware information of the IoT device.

In an example, the method may further comprise transmitting, by the server, a request to record cancellation of user use registration as a transaction in the blockchain of the blockchain system to the blockchain system.

In an example, the verifying may comprise determining that the devices is not a validly usable device, when firmware information of the IoT device included in the search result information associated with the device information received from the blockchain system does not satisfy conditions of firmware information for the service use.

In an example, the method may further comprise transmitting, by the server, a firmware update request message to a client or the IoT device, when it is determined that the firmware information of the IoT device does not satisfy conditions of firmware information for the service use.

In each of the examples above, the verifying may comprise determining that the device is not a validly usable device, when at least one of information indicating that the device has been hacked, information indicating that the device has been used illegally, and information indicating that there is an error in some or all of functions of the device is recorded in history information of the IoT device included in the search result information associated with the device information received from the blockchain system.

A method for managing information of an IoT device performed by a device (server or client) managing the information of the IoT device according to another example of the present invention may comprise: receiving device information including identification information of the IoT device associated with updated firmware; retrieving the received device information in a blockchain of a blockchain system to receive search result information associated with the device information recorded as a transaction in the blockchain from the blockchain system; and verifying whether the IoT device is a device registered as a validly usable device and/or whether the updated firmware associated with the IoT device is validly registered based on the received search result information.

In an example, the method may further comprise: transmitting a request for transmission of the updated firmware registered with the blockchain in relation to the IoT device in the blockchain system to the blockchain system, when the IoT device is verified as a device registered as a validly usable device and the updated firmware associated with the IoT device is verified as validly registered; and receiving the firmware recorded as a transaction in the blockchain of the blockchain system.

In an example, the method may further comprise: receiving the firmware from the blockchain system and then transmitting the received firmware to the IoT device; receiving a message informing completion of installation of the firmware from the IoT device; and transmitting a request to record firmware update completion information as a transaction in the blockchain of the blockchain system to the blockchain system.

The blockchain of the blockchain system in the present invention may be a permissioned blockchain, which requires prior permission for participation and sets authority for the blockchain for each participant.

Additionally, the blockchain may comprise at least one block connected by hash chain, and the blockchain system may comprise at least one node, which may verify the validity of the transaction corresponding to the request to record and the block comprising at least the transaction based on a predefined consensus algorithm and then add the block comprising the transaction to the blockchain.

A device managing the information of an IoT device according to another example of the present invention may be a device managing the information of an IoT device comprising a memory; and at least one processor connected to the memory, wherein the at least one processor may be configured to perform processing of each step described in each of the above-mentioned methods.

A computer-readable storage medium storing codes executable by at least one processor of a device managing the information of an IoT device according to another example of the present invention may be a computer-readable storage medium storing codes to perform processing of each step described in each of the above-mentioned methods when the codes are executed.

According to an IoT device managed based on a blockchain and system and method thereof according to the present invention, it is possible to enhance security of maintenance and management of IoT devices and services related thereto.

More specifically, in distributing and using an IoT device, the history of device information may be managed in correlation with a blockchain to allow management under which changes cannot be made to the history after-the-fact in principle, thereby increasing reliability of a service using the IoT device. In addition, since service information or firmware information associated with an IoT device is managed in correlation with a blockchain, it is difficult to forge or temper with the information, or for a particular entity to arbitrarily control the information. Accordingly, the present invention can improve security of services using the IoT device and maintenance and management of firmware.

### BRIEF DESCRIPTION OF THE DRAWING

FIG. 1 is a diagram illustrating an IoT device management system managed based on a blockchain according to an example of the present invention.

FIG. 2 is a diagram illustrating a method for blockchain registration and cancellation of basic information of an IoT device and user information according to an example of the present invention.

FIG. 3 is a diagram illustrating a method for blockchain registration and cancellation of service use information of an IoT device according to an example of the present invention.

FIG. 4 is a diagram illustrating a method for firmware update of an IoT device correlated with a blockchain system according to an example of the present invention.

FIG. 5 is a block diagram illustrating a device according to an example of the present invention.

### DETAILED DESCRIPTION

Hereinafter, various examples of the present invention are described, but the technical idea of the present invention is not limited thereto and can be modified and implemented in a variety of manners by those skilled in the art. In addition, the terms used herein are used to describe the concept of the present invention and the examples thereof and are not intended to limit the present invention to the dictionary or literal meanings of the terms. For example, singular forms herein may include their plural forms unless the context clearly indicates otherwise. Also, the term ‘comprise’ or ‘have’ herein means the presence of any feature, step, operation or combination thereof, and possibility of presence or addition of other features, steps, or operations are not excluded unless the context clearly indicates otherwise.

Unless stated otherwise herein, ‘accessed’ or ‘connected’ may mean that one element or characteristic is directly accessed or connected to another element or characteristic or indirectly accessed or connected via another element or characteristic, and may not necessarily mean being directly accessed or connected mechanically. Thus, while the various schematic diagrams shown in the drawings show exemplary arrangements of elements and components, additional mediating elements, devices, characteristics or components may be present in actual embodiments (assuming that the functionality of the illustrated elements are not adversely affected).

Additionally, ‘transmitting’ or ‘receiving’ herein may include not only directly transmitting or receiving information between a sender and a receiver, but also transmitting or receiving information via another object unless otherwise stated.

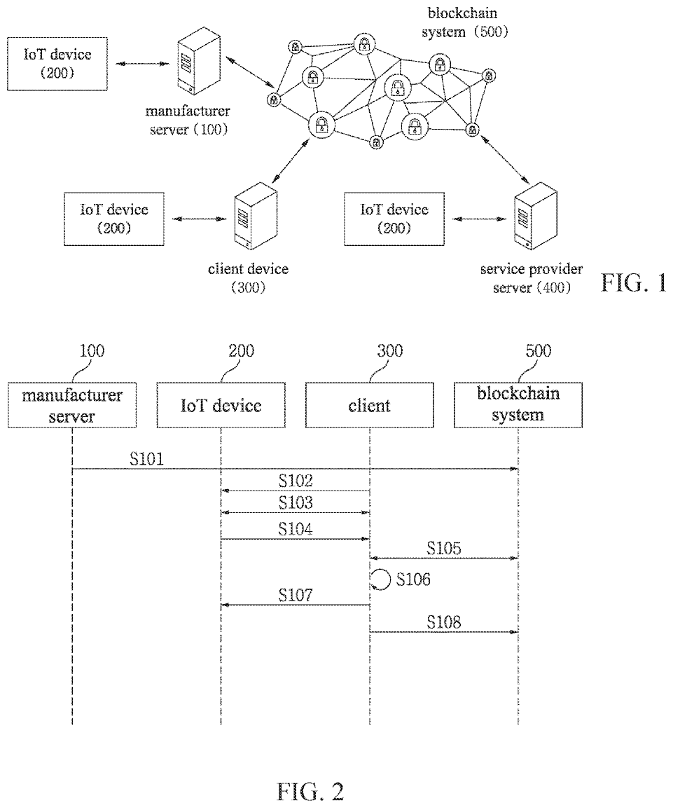

FIG. 1 is a diagram illustrating an IoT device management system according to the present invention.

The IoT device management system according to the present invention may comprise at least one of a manufacturer server 100 operated by the manufacturer of an IoT device 200, the IoT device 200, a client device 300 operated by a user of the IoT device 200, and a service provider server 400 operated by a service provider which provides a service using the IoT device 200, and may comprise a blockchain system 500 correlated with at least one of them.

In one example, the manufacturer and the service provider may be the same entity, in which case the manufacturer server 100 and the service provider server 400 may be the same server.

In the present invention, the blockchain system used by the IoT device management system is configured in the form of a permissioned blockchain in which only those who are authorized through authentication participate in the blockchain to improve security and management efficiency. In addition, in the present invention, the manufacturer producing an IoT device records basic information including a unique ID of the device for management of the IoT device in a blockchain. Further, in the present invention, a user of the IoT device records registration and cancellation of user information with the blockchain so that the owner of the IoT device can be identified. In addition, in the present invention, a service provider confirms safety of the IoT device through the blockchain and records registration and cancellation of a service related to the device with the blockchain. In addition, when there is a firmware update in the present invention, stability and security of the firmware update are improved by updating the firmware in correlation with the blockchain.

Hereinafter, in relation to the IoT device management system according to the present invention, operations of the blockchain system 500, and the IoT device 200, the manufacturer server 100, the client device 300, and the service provider server 400 in correlation thereto are described in more detail.

### 1) Blockchain System

The blockchain system 500 according to the present invention has the following characteristics.

The blockchain system 500 according to the present invention may comprise a plurality of nodes, and all or at least some of the nodes may perform at least one of the following operations: receiving a newly occurred transaction described below, creating a block including the transaction, transmitting a request to add the created block to a blockchain to another node, and verifying a request to add a block received from another node according to a predefined consensus algorithm so as to add the block to its own blockchain or to the blockchain to which it is connected. Hereinafter, a device that performs at least one of the above-described operations is referred to as a node.

Additionally, the blockchain system 500 according to the present invention is correlated with at least one of the IoT device 200, the manufacturer server 100, the client device 300, and the service provider server 400. Each of the devices may function as a node by directly performing at least one of the above-described operations of a node, or it may be connected to a node included in the blockchain system 500 to function as such without directly performing the above-described operations of a node and be correlated with the blockchain system 500 by transmitting a request to trigger the function of a node and receiving a response to it. That is, the IoT device 200, the manufacturer server 100, the client device 300, and the service provider server 400 may be the aforementioned nodes or may be connected to a node.

Each block of the blockchain of the present invention is connected in the form of hash chain. That is, the n-th block stores a hash value of the n−1-th block coming before it. Therefore, a change to the information in any one block causes a change of the hash value calculated from the block, leading to a change in the contents of the next block, which essentially causes a change to information of all of the blocks following the block. Here, the hash value may be calculated by a hash function that converts any arbitrary data into data having a predetermined size. For example, a hash function may be selected as necessary, such as MD5, SHA1, or SHA2.

A block of the present invention includes at least one transaction. In one example, a block may include a time stamp, and the time stamp may indicate time information (e.g., block creation time) associated with the block and/or the transaction.

A transaction of the present invention may be configured according to information from each subject (the IoT device 200, the manufacturer server 100, the client device 300, service provider server 400) correlated with the blockchain system 500 and/or the nodes participating in the blockchain system 500. For example, registration, change, or discard of specific information requested by each subject may be configured as one transaction. The transaction may be created at each subject or at a node of the blockchain system 500 that receives specific information from each subject.

In one example, each transaction may be digitally signed and verified by public-key cryptography (PKC). To this end, a digital signature, where information on a transaction (e.g., a hash value calculated by making the transaction at least one of the inputs of a hash function) is signed with a private key, and a public key may be included in the transaction or provided to a node via another path. The node can then verify the digital signature using the public key to verify the validity of the transaction. In addition, ownership of our association with the transaction may be demonstrated through a private key held by the owner of the transaction or by an entity involved in the creation of the transaction.

Here, the public key and the private key may be created by a subject involved in the transaction. Preferably, in the case of a permissioned blockchain, they may be issued by a membership manager who manages participation in the blockchain system 500 and provided to a subject involved in the transaction.

Here, each transaction may be signed and verified by another known cryptographic scheme other than the public-key cryptography described above.

Each subject correlated with the blockchain system 500 and/or nodes participating in the blockchain system 500 in the present invention create a transaction, and transmit and/or broadcast it to nodes participating in the blockchain system 500.

All or some of the nodes participating in the blockchain system 500 of the present invention may create a new block that comprises at least one transaction newly occurring in the system. The nodes can also verify the validity of the transaction. In addition, the nodes can make a request to other nodes to add the newly created block to an existing blockchain.

In the present invention, the nodes of the system receiving the request verify the validity of the transaction and/or the block according to a predefined consensus algorithm described below and, if the verification succeeds, add the block its own blockchain or to the blockchain to which it is connected.

The nodes participating in the blockchain system 500 of the present invention preferably hold or access a unified blockchain, and share it. To this end, all or some of the nodes participating in the blockchain system 500 may, according to a predefined consensus algorithm, perform at least one of the following: verification of validity of a block and/or a transaction, determination of order of blocks and/or transactions, and addition of a new block to a blockchain. And, only a block verified by the consensus algorithm can be finally added to the blockchain. Here, a plurality of blockchains to which blocks are temporarily added may exist simultaneously in the blockchain system 500, and a blockchain determined to be invalid by subsequent verification by the consensus algorithm may be discarded, by which the final blockchain may be determined. As a result, the blockchains owned or accessed by each node may be conformed and shared with each other.

The consensus algorithm of the present invention may be an algorithm defined to perform the above function, and is not limited to a specific consensus algorithm. For example, a proof-of-work (POW) algorithm, a proof-of-stake (POS) algorithm, a practical Byzantine fault tolerance (PBFT) algorithm, a proof of elapsed time (PoET) algorithm may be used, or any algorithm designed to perform the function may be used.

The blockchain system 500 according to the present invention is preferably operated in the form of a permissioned block chain for security of the IoT device 200. In a permissioned blockchain, only authorized participants can access the blockchain, and authority may be set for the access.

In the present invention, at least one of the IoT device 200, the manufacturer server 100, the client device 300, and the service provider server 400 may be granted permission through authentication from a membership manager in order to participate in the blockchain system 500 of the present invention operated in the form of a permissioned block chain, and authority for the blockchain may be set at the time of permission. For example, the manufacturer or the service provider may be given greater authority (e.g., authority to update firmware), and the user may be granted less authority (e.g., authority to read firmware information).

Thus, in one example of the present invention using the blockchain system 500 based on a permissioned blockchain, illegal attacks for illicit use of the IoT device 200 can be suppressed.

Additionally, in one example of the present invention using the blockchain system 500 based on a permissioned blockchain, since a participant may be identified even if the participant is anonymous, different policies may be applied to identified participants, or levels of access to details of transactions may be differentiated. That is, there may be a difference in information that can be accessed and set up in the blockchain according to the set authority. For example, according to the set authority, accessibility to blocks of a blockchain and information readable in a transaction may be limited, and the content of a transaction and/or a block that may be included in the blockchain may be limited. In addition, only certain authorized nodes may be able to create a block and add it to the blockchain. For example, only the manufacturer server 100 or the service provider server 400 may request to register firmware or software installed on the IoT device 200 with the blockchain, and the client device 300 of the user may be authorized to only download registered firmware or software.

Therefore, in one example of the present invention using the blockchain system 500 based on the permissioned blockchain, more details of information of the IoT device 200 and information provided by the associated manufacturer or service provider may be recorded in a transaction to be provided to the participants through the blockchain, while also ensuring that only participants who have acquired certain authority can selectively access the information. This improves the security of management of the IoT device 200 while allowing recording and utilizing more information based on controlled disclosure of information about the IoT device 200.

In one example of the present invention using the blockchain system 500 based on the permissioned blockchain, a membership manager who is involved in the blockchain system 500 and manages participation by participants may access the blockchain system 500 as an administrator server or the like so that only those authorized can access the blockchain. Or there may be no separate manager, and membership management may be performed in a shared, distributed manner according to an agreed protocol which is predefined and shared among the participants.

Meanwhile, when digitally signing and verifying a transaction by public-key cryptography (PKC), the public and private keys may be created by a subject involved in the transaction, but in a permissioned blockchain, they are may be preferably issued by a membership manager who manages participation in the blockchain system 500 and provided to a subject involved in the transaction.

The blockchain system 500 of the present invention is characterized in that it includes the above-described characteristics in the blockchain, and to this end, it is possible to use and customize a known blockchain to provide the above-described characteristics. For example, a known permissioned blockchain system, such as a Hyperledger fabric blockchain, may be configured and used to provide the characteristics described above.

Hereinafter, the IoT device and management system and method thereof of the present invention managed by the IoT device 200, the manufacturer server 100, the client device 300, and the service provider server 400 correlated with the blockchain system 500 according to the present invention described above are described.

### 2) Blockchain Registration and Cancellation of Basic Information of an IoT Device and User Information

Hereinafter, referring to FIG. 2, registration and cancellation of basic information of the IoT device 200 and user information in the blockchain according to an example of the present invention are described.

First, the manufacturer server 100 managed by the manufacturer of the IoT device 200 transmits a request to the blockchain system 500 to record basic information about the IoT device 200 with the blockchain, and in response, the blockchain system 500 creates a block comprising a transaction in which the requested basic information of the IoT device 200 is recorded (S101). At least one node of the blockchain system 500 may then create a block comprising a transaction in which the basic information of the IoT device 200 is recorded in response to the request, and validity of the transaction and/or the block may be verified by a predefined consensus algorithm.

The block thus created may be added to an existing blockchain or may be registered with the blockchain as the first block for creating a new blockchain for the device. In the latter case, when a new transaction about the device occurs later, a new block may be added to the registered block to extend the blockchain.

Basic information of the IoT device 200 registered as a transaction may be a unique ID of the device, a model name or model number of the device, firmware information (such as firmware hash or version information) of the device, other product information of the device, and the like.

The IoT device 200 whose basic information was registered with the blockchain as above may be acquired by a user through a method such as purchase or rental via a distribution channel. The user may be the first user to use the IoT device 200 or may be a user who has acquired and used a device that has already been used by another entity. Therefore, in addition to the basic information recorded by the manufacturer server 100 in the blockchain associated with the device, information recorded by another subject about the device may be included in the form of a transaction.

The user who has acquired the IoT device 200 may access the IoT device 200 via various networks, or wired or wireless connections through a client device 300 (for example, a computer, a laptop, a mobile device, etc.) operated by the user, and transmits a request for user registration to the IoT device 200 (S102). In the present invention, the operation of registering a user with the IoT device 200 is performed in correlation with the blockchain system 500 as described below.

The client device 300 sets a security protocol with the IoT device 200 (S103) and receives unique information of the IoT device 200 from the IoT device 200 (S104). The transmitted unique information of the IoT device 200 may be a unique ID of the device, firmware information, and the like.

Here, the security protocol setting between the client device 300 and the IoT device 200 (S103) may be made before the step of requesting user registration (S102), if necessary.

The client device 300 retrieves unique information (e.g., device ID) of the IoT device 200 received from the IoT device 200 in the blockchain of the blockchain system 500 (S105). The client device 300 may directly access the blockchain to retrieve unique information of the IoT device 200 from the transactions included in the block of the blockchain to obtain search result information, or may transmit a request to retrieve it to a node of the blockchain system 500 and receive search result information from the node. The search result information may be, for example, information indicating whether or not the IoT device 200 on which the retrieval was requested is a device registered with the blockchain or whether or not the device is registered as a validly usable device. Further, in one example, for the purpose of retrieval, the client device 300 may transmit unique information of the IoT device 200 to the blockchain system 500, or the IoT device 200 may transmit the unique information directly to the blockchain system 500 if necessary.

The client device 300 verifies whether the IoT device 200 is a device registered as a validly usable device based on the retrieved search result information (S106).

If the obtained search result information confirms that the device is a device that is not registered with the blockchain or that the information indicating that the device is registered but is not a validly usable device is registered, the client device 300 may check the information and perform a process to stop or reject user registration for the device. For example, if the IoT device 200 has a history of being hacked, illegally used as a bot or the like, wholly or partially inoperable, or the like, the history information may be recorded in the form of a transaction in the blockchain associated with the IoT device 200. The history information may be information indicating that the device is not a validly usable device and may be recorded in a transaction in a predefined form so as to indicate the history.

After it is verified that the IoT device 200 is a device registered as a validly usable device, the client device 300 transmits a message indicating completion of user registration to the IoT device 200 or registers user information with the IoT device 200 if necessary (S107).

Additionally, the client device 300 transmits a request to record user registration information in the blockchain with the blockchain system 500, and in response, the blockchain system 500 creates a block comprising a transaction in which the requested user registration information is recorded and adds it to the blockchain (S108). At least one node of the blockchain system 500 may then create a block comprising a transaction in which the user registration information is recorded in response to the request, and validity of the transaction and/or the block may be verified by a predefined consensus algorithm.

Here, the user registration information may include information related to the user or the client device 300 and may be included in the form of a user ID or anonymized information. In addition, a digital signature of the user, a public key corresponding to the private key held by the user, a hash value thereof, and the like may be included. In addition, the user registration information may further include information about the IoT device 200 used by the user. For example, an ID or firmware information of the device may be further included.

Also, in one example, the step of creating a block comprising a transaction in which user registration information is recorded and adding the block to the blockchain (S108) may be performed before the step of transmitting a message indicating completion of user registration to the IoT device 200 or registering user information with the IoT device 200 (S107).

For the purpose of cancellation of user registration, the client device 300 transmits a request to the blockchain system 500 to record the cancellation of the user registration in the blockchain, and in response, the blockchain system 500 creates a block comprising a transaction in which the requested cancellation of the user registration is recorded and adds it to the blockchain (S109). At least one node of the blockchain system 500 may then create a block comprising a transaction in which the cancellation of the user registration is recorded in response to the request, and validity of the transaction and/or the block may be verified by a predefined consensus algorithm.

Additionally, the client device 300 may transmit a message indicating the cancellation of the user registration to the IoT device 200 or perform a process to cancel or delete the user information registered with the IoT device 200 if necessary (S110). For example, a process of changing user-related information to other information may be performed. In one example, that process may be performed by the IoT device 200 that conformed the user registration cancellation from the blockchain.

Additionally, in one example, the step of the client device 300 transmitting a message indicating the cancellation of the user registration to the IoT device 200 or performing a process of cancelling or deleting the user information registered with the IoT device 200 (S110) may be performed before the step of creating a block comprising a transaction in which the cancellation of the user registration is recorded and adding it to the blockchain (S109).

### 3) Registration of Service Use Information of an IoT Device with a Blockchain and Cancellation Thereof

Hereinafter, referring to FIG. 3, registration of service use information of an IoT device 200 with the blockchain and cancellation thereof according to an example of the present invention are described.

The user of the IoT device 200 transmits a request for service use registration to the service provider server 400 through the client device 300 (S201). In one example, the user may transmit a request for service use registration of the IoT device 200 to the service provider server 400 through the IoT device 200.

Here, for the service, the IoT device 200 is used and the service is implemented by controlling the IoT device 200 by operation of firmware and/or software installed on the IoT device 200. To this end, the service provider and/or the manufacturer may provide firmware and/or software properly designed for use of the service to the IoT device 200, or they can be provided via the client device 300 if necessary. The above-mentioned service is operated by the service provider and provided to users, and in order to use the service, the client device 300 and/or the IoT device 200 has to have service use information registered, so that it can be confirmed by the service provider. In the present invention, such registration of service use information is performed in correlation with the blockchain.

After receiving the service use registration request, the service provider server 400 requests the service use registration to the IoT device 200 (S202). In the present invention, the operation of registering service use of the IoT device 200 is performed in correlation with the blockchain system 500 as described below.

The service provider server 400 sets a security protocol with the IoT device 200 (S203) and receives unique information of the IoT device 200 from the IoT device 200 (S204). The transmitted unique information of the IoT device 200 may be a unique ID of the device, firmware information, and the like.

Here, the security protocol setting between the service provider server 400 and the IoT device 200 (S203) may be made before the step of requesting the registration of service use (S202) if necessary.

The service provider server 400 retrieves unique information (e.g., device ID) of the IoT device 200 received from the IoT device 200 in the blockchain of the blockchain system 500 (S205). The service provider server 400 may directly access the blockchain to retrieve unique information of the IoT device 200 from the transactions included in the block of the blockchain to obtain search result information, or may transmit a request to retrieve it to a node of the blockchain system 500 and receive search result information from the node. The search result information may be, for example, information indicating whether or not the IoT device 200 on which the retrieval is requested is a device registered with the blockchain or whether or not the device is registered as a validly usable device.

The service provider server 400 verifies whether the IoT device 200 is a device registered as a validly usable device based on the acquired search result information (S206). Depending on the verification result, the service use information may additionally be registered with the server.

If the obtained search result information confirms that the device is a device that is not registered with the blockchain or that the information indicating that the device is registered but is not a validly usable device is registered, the service provider server 400 may check the information and perform a process to stop or reject service use registration for the device. For example, if the IoT device 200 has a history of being hacked, illegally used as a bot or the like, wholly or partially inoperable, or the like, the history information may be recorded in the form of a transaction in the blockchain associated with the IoT device 200. The history information may be information indicating that the device is not a validly usable device and may be recorded in a transaction in a predefined form so as to indicate the history.

Here, if the service provider server 400 checks the version of the firmware of the device from the acquired search result information and as a result, determines that a firmware update is necessary, the service provider server 400 may transmit a firmware update request message to the client device 300 and/or the IoT device 200. The client device 300 and/or the IoT device 200 receiving the request message may perform a process for the firmware update of the IoT device 200. For example, the client device 300 and/or the IoT device 200 may access the manufacturer server 100, the service provider server 400, or another server storing a new version of the firmware to receive the firmware and execute an instruction to install the received new version of the firmware on the IoT device 200. Or the firmware may be acquired from the blockchain system 500 by the method described below and then installed.

The client device 300 and/or the IoT device 200 may transmit a firmware update result to the service provider server 400, or a request to the blockchain system 500 so that the firmware update result is configured as a transaction to be added to the blockchain. In the latter case, the service provider server 400 may check the firmware update result of the IoT device 200 from the blockchain associated with the device.

The service provider server 400 may check the firmware update result and may perform a process to stop or reject service use registration for the IoT device 200 on which a necessary firmware update has not been executed.

In the above-described viewpoints, the service provider server 400 may verify whether the IoT device 200 is a device registered as a validly usable device for a service based on the acquired search result information but is not limited to the above examples, and the criteria for determination on whether the device is validly usable for a service may be set depending on the required service.

After it is verified that the IoT device 200 is a device registered as a validly usable device for a service, the service provider server 400 transmits a message indicating completion of service use registration to the IoT device 200 and/or the client device 300 (S207, S208). Here, it is obvious that a message indicating completion of service use registration may be transmitted to the IoT device 200 via the client device 300 and that the message may be transmitted to the client device 300 via the IoT device 200.

Additionally, the service provider server 400 transmits a request to record service use registration information with the blockchain to the blockchain system 500. In response, the blockchain system 500 creates a block comprising a transaction in which the requested service use registration information is recorded and adds it to the blockchain (S209). At least one node of the blockchain system 500 may then create a block comprising a transaction in which the service use registration information is recorded in response to the request, and validity of the transaction and/or the block may be verified by a predefined consensus algorithm.

Here, the service use registration information may include an ID of the service provider, a service code for identifying a service, and the like. In addition, it may additionally include an ID and firmware information of the device and further include user information if necessary.

Also, in one example, the step of creating a block comprising a transaction in which service use registration information is recorded and adding the block to the blockchain (S209) may be performed before the step of transmitting a message indicating completion of service use registration to the IoT device 200 and/or the client device 300 (S207, S208).

For the purpose of cancellation of service use registration, the service provider server 400 transmits a request to the blockchain system 500 to record the cancellation of the service use registration with the blockchain. In response, the blockchain system 500 creates a block comprising a transaction in which the requested cancellation of the service use registration is recorded and adds it to the blockchain (S210). At least one node of the blockchain system 500 may then create a block comprising a transaction in which the cancellation of the service use registration is recorded in response to the request, and validity of the transaction and/or the block may be verified by a predefined consensus algorithm.

In one example, prior to creating and adding a block, the service provider server 400 may retrieve the corresponding service in the blockchain of the blockchain system 500, confirm that the service is a registered one, and then cancel the service use registration. In addition, in one example, the request for cancellation of the service use registration may be transmitted by the client device 300 instead of the service provider server 400.

Additionally, the service provider server 400 may transmit a message indicating the cancellation of the service use registration to the IoT device 200 or perform a process to cancel or delete the service use information registered with the IoT device 200 as necessary (S211). For example, a process of changing the service use information to other information may be performed. In one example, the processing may be performed by the client device 300 or the IoT device 200.

Additionally, in one example, the step of transmitting a message indicating the cancellation of the service use registration to the IoT device 200 or performing a process to cancel or delete the service use information registered with the IoT device 200 (S211) may be performed before the step of creating a block comprising a transaction in which the cancellation of the service use registration is recorded and adding it to the blockchain (S210).

### 4) Firmware Update of the IoT Device Correlated with the Blockchain System 500

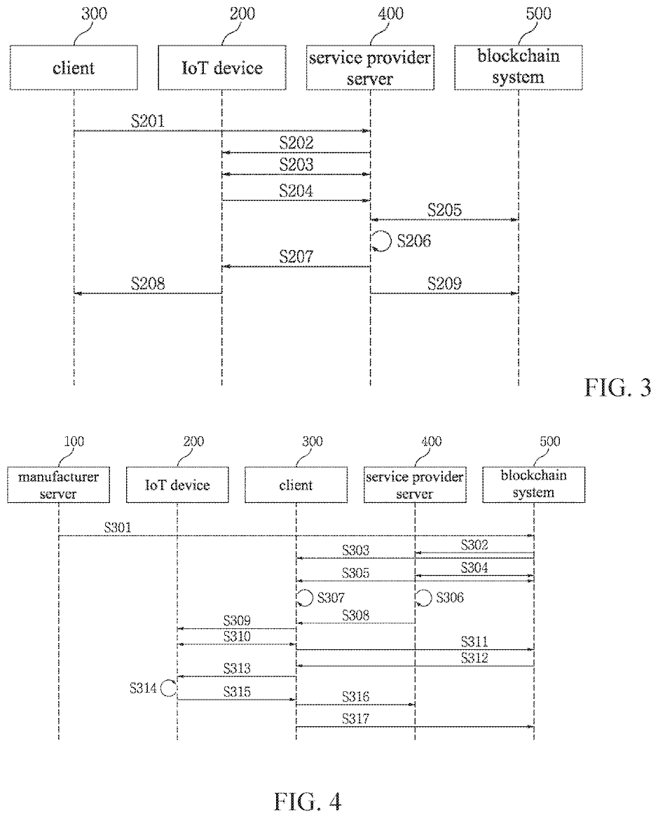

Hereinafter, referring to FIG. 4, firmware update of the IoT device 200 correlated with the blockchain system 500 according to an example of the present invention is described.

When a firmware update event occurs, the manufacturer server 100 performs a process to record firmware update information with the blockchain (S301). To this end, the manufacturer server 100 transmits a request to record the firmware update information with the blockchain to the blockchain system 500, and in response, the blockchain system 500 creates a block comprising a transaction in which the requested firmware update information is recorded. At least one node of the blockchain system 500 may then create a block comprising a transaction in which the firmware update information is recorded in response to the request, and validity of the transaction and/or the block may be verified by a predefined consensus algorithm

The firmware update information registered as a transaction may include information about the IoT apparatus 200 such as an ID of the device, updated firmware, information about it, and the like.

When firmware update information of a particular IoT device 200 is recorded with the blockchain, the blockchain system 500 transmits a message indicating that a firmware update event has occurred to the client device 300 of the user of the IoT device 200 and/or the service provider server 400 (S302, S303). The message may include identification information of the IoT apparatus 200 associated with the updated firmware and may include at least part of the firmware update information. Here, the association between pieces of information may be confirmed if they are found to be pieces of information included in transactions contained in the same blockchain. In addition, the message transmission may be performed by a node of the block chain system 500. Or in one example, the manufacturer server 100 may transmit a message indicating that a firmware update event has occurred to the client device 300 and/or the service provider server 400, and the service provider server 400 may transmit the message to the client device 300. In addition, the manufacturer server 100 and/or the service provider server 400 may check the record of the firmware update information from the blockchain of the blockchain system 500 before transmitting the message and transmit the message.

The client device 300 and/or the service provider server 400 receiving the message indicating the occurrence of the firmware update event as described above retrieve unique information of the IoT device 200 and/or firmware update information associated with the message in the blockchain of the blockchain system 500 (S304, S305). The client device 300 and/or the service provider server 400 may directly access the blockchain to retrieve unique information of the IoT device 200 and/or firmware update information from the transactions included in the block of the blockchain to obtain search result information, or transmit a request to retrieve it to a node of the blockchain system 500 and receive search result information from the node. The search result information may be information indicating whether or not the IoT device 200 and/or the firmware update on which the retrieval is requested are a device or a firmware update validly registered with the blockchain.

The client device 300 and/or the service provider server 400 verify whether the IoT device 200 and/or the firmware update are validly registered with the blockchain based on the acquired search result information (S306, S307). If the obtained search result information confirms that the device and/or the firmware update are not registered with the blockchain or that the information indicating that they are registered but are not a valid device and/or firmware update is registered, the client device 300 and/or the service provider server 400 may check the information and perform a process to stop or reject a subsequent procedure for firmware update for the device.

If the verification is successful, the service provider server 400 may transmit a message requesting a firmware update to the client device 300 of the user of the device (S308). In an example, the service provider server 400 may transmit a message requesting a firmware update to the IoT device 200. Or the client device 300 may transmit a message requesting a firmware update to the IoT apparatus 200 (S309).

For the purpose of communication for a firmware update, the client device 300 may set a security protocol with the IoT device 200 (S310). Such a security protocol setting may be performed at any point in time as needed, and preferably, before the client device 300 transmits the firmware to the IoT device 200.

The client device 300 may transmit a request for transmission of a firmware registered with the blockchain with respect to the IoT device 200 to the blockchain system 500 (S311), and in response, the blockchain system 500 may transmit the firmware registered with the blockchain with respect to the device to the client device 300 (S312). In one example, the IoT device 200, instead of the client device 300, may transmit the request for transmission of the firmware, and in response, the blockchain system 500 may transmit the firmware to the IoT device 200. Or the service provider server 400 may transmit the request for transmission of the firmware, and in response, the blockchain system 500 may transmit the firmware to the service provider server 400, and the received firmware may be transmitted to the client device 300 and/or the IoT device 200. In addition, a node of the blockchain system 500 may receive the request for transmission of the firmware, and in response, transmit the firmware to the client device 300 and/or the IoT device 200. When the client device 300 receives the firmware, the client device 300 may transmit the received firmware to the IoT apparatus 200 (S313).

The IoT device 200 updates the existing firmware to the received firmware (S314). Here, the device may verify the validity of the received firmware. The validity verification may be performed by the device itself or in correlation with the blockchain system 500 if necessary in the same manner as the one performed in the steps S306 and S307, that is, by the IoT device 200 checking registered information of the firmware in the blockchain.

When the update is completed, the IoT device 200 transmits a message informing the completion of the firmware update to the client device 300 and/or the service provider server 400 (S315). Here, the client device 300 may transmit a message informing the completion of the firmware update to the service provider server 400 (S316).

Additionally, the client device 300 transmits a request to the blockchain system 500 to record firmware update completion information with the blockchain, and in response, the blockchain system 500 creates a block comprising a transaction in which the requested firmware update completion information is recorded (S317). At least one node of the blockchain system 500 may then create a block comprising a transaction in which the firmware update completion information is recorded in response to the request, and validity of the transaction and/or the block may be verified by a predefined consensus algorithm. The IoT device 200 or the service provider server 400, instead of the client device 300, may transmit the request to the blockchain system 500.

According to the IoT device managed based on a blockchain and the system and method thereof according to the present invention, it is possible to manage the history of information of the device during its distribution and use, which improves the reliability of a service using the IoT device. That is, in the blockchain of the present invention, if device information is included in the blockchain as a transaction, it is impossible in principle to delete or change the recorded device information without changing the blockchain due to the nature of the blockchain connected by hash chain, which makes it difficult to forge or temper with the device's history. In addition, it is difficult for not only unauthorized attackers but also associated operators such as manufacturers and service providers to unilaterally control information recorded in the blockchain in violation of a consensus algorithm of the nodes of the blockchain system. Therefore, the risk that history of distribution or use of the IoT device is changed or deleted or recorded inaccurately can be suppressed.

Further, according to the IoT device managed based on a blockchain and the system and method thereof according to the present invention, since service information associated with the IoT device is also managed in correlation with the blockchain system of the present invention, it is difficult to forge or temper with it, as with the above-mentioned device history, and it is also difficult for a particular entity to unilaterally control the information. Therefore, the security of a service using the IoT device can be improved.

In addition, according to the IoT device managed based on a blockchain and the system and method thereof according to the present invention, since firmware update information associated with the IoT device is also managed in correlation with the blockchain system of the present invention, it is difficult to forge or temper with it, and it is also difficult for a particular entity to unilaterally control the information. Therefore, the security of maintenance and management of firmware of the IoT device can be improved.

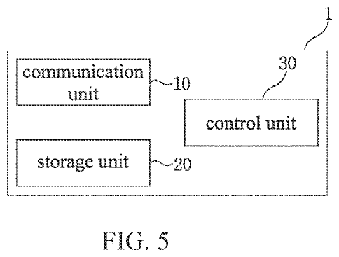

The IoT device 200, the manufacturer server 100, the client device 300, and the service provider server 400 of the present invention may be configured to comprise, as shown in FIG. 5, a communication unit, a storage unit (transitory or non-transitory storage device, memory, etc.), and a control unit (at least one processor or logic circuit, etc.). Here, the storage unit may temporarily or non-temporarily store at least part of program instructions and databases for executing functions of each device, and the above-described functions of each device may be executed as the program instructions stored in the storage unit are executed at the control unit. A commercially available computer may be used as such a device and an embedded system may be designed and used.

Additionally, nodes included in the block chain system 500 may also be configured to comprise a communication unit, a storage unit, and a control unit as shown in FIG. 5. Here, the storage unit may store at least part of information of the blockchain and may temporarily or non-temporarily store at least part of program instructions and databases for executing functions of the nodes, and the above-described functions of the nodes may be executed as the program instructions stored in the storage unit are executed at the control unit.

The order of the operations described in the methods or processes disclosed herein is described as an example. Thus, the order of the steps may be adjusted as necessary within the idea of the present invention. In addition, the devices and systems disclosed herein may comprise means for performing the functions described herein and may be implemented as an independent device or system or correlated or integrated with another system as necessary.

The techniques described herein may be implemented at least in part in hardware, software, firmware, or any combination thereof. These may be implemented, for example, in at least one processor, DSP, ASIC, FPGA, equivalent integrated or discrete logic circuit, or any combination of at least one of them. Such hardware, software, and firmware may be implemented within one or a plurality of systems or devices to support the operations and functions disclosed herein, or may be implemented in the form of being correlated or integrated with another system or device. In addition, although the components described herein are separate, they may be implemented together with or separately from logic devices that can be operated together. Each of the functions and operations described separately herein is described as such to emphasize each function, and such functions are not necessarily to be realized in separate hardware, firmware, or software components and may be integrated into a combination of common or separate hardware and/or software. The term “processor” or “processing circuit” may generally refer to any of the foregoing logic circuits alone or in combination with another logic circuit, or any other equivalent circuit. A control unit that comprises hardware may perform at least one of the techniques disclosed herein.

In addition, the techniques described herein may also be implemented or stored in a computer-readable storage medium storing instructions. And, instructions stored on a computer-readable medium may cause method and operation associated with the instructions to be performed by a processor in each device. Computer-readable storage media may include RAM, ROM, PROM, EPROM, EEPROM, flash memory, hard disk, CD-ROM, magnetic media, optical media, or other storage media.

### Description of Reference Numerals

100 manufacturer server

200 IoT device

300 client device

400 service provider server

500 blockchain system

What is claimed is:

1. A method for managing information of an IoT device performed by a client, comprising:
transmitting a request for user registration to the IoT device;
receiving device information including identification information of the IoT device from the IoT device;
retrieving the received device information in a blockchain of a blockchain system to receive search result information associated with the device information recorded as a transaction in the blockchain from the blockchain system; and
verifying whether the IoT device is a device registered as a validly usable device based on the received search result information.

2. The method according to claim 1, further comprising transmitting, by the client, a request to record user registration information as a transaction in the blockchain of the blockchain system to the blockchain system, when the IoT device is verified as a device registered as a validly usable device in the verification step.

3. The method according to claim 2,
wherein the device information further comprises firmware information of the IoT device, and
the user registration information comprises at least one of identification information of the IoT device, user information, and firmware information of the IoT device.

4. The method according to claim 2, further comprising transmitting, by the client, a request to record cancellation of user registration as a transaction in the blockchain of the blockchain system to the blockchain system.

5. The method according to claim 1,
wherein the verifying comprises determining that the device is not a validly usable device, when at least one of information indicating that the device has been hacked, information indicating that the device has been used illegally, and information indicating that there is an error in some or all of functions of the device is recorded in history information of the IoT device included in the search result information associated with the device information received from the blockchain system.

6. The method according to claim 1,
wherein the blockchain of the blockchain system is a permissioned blockchain, which requires prior permission for participation and sets authority for the blockchain for each participant.

7. The method according to claim 2,
wherein the blockchain comprises at least one block connected by hash chain, and
the blockchain system comprises at least one node, which verifies the validity of the transaction corresponding to the request to record and the block comprising at least the transaction based on a predefined consensus algorithm and then adds the block comprising the transaction to the blockchain.

8. A method for managing information of an IoT device performed by a server, comprising:
receiving device information including identification information of the IoT device from the IoT device responding to a request for service use registration;
retrieving the received device information in a blockchain of a blockchain system to receive search result information associated with the device information recorded as a transaction in the blockchain from the blockchain system; and
verifying whether the IoT device is a device registered as a validly usable device based on the received search result information.

9. The method according to claim 8, further comprising transmitting, by the server, a request to record service use registration information as a transaction in the blockchain of the blockchain system to the blockchain system, when the IoT device is verified as a device registered as a validly usable device,

10. The method according to claim 9,
wherein the device information further comprises firmware information of the IoT device, and
the service use registration information comprises at least one of a code specifying a service, identification information of the IoT device, user information, and firmware information of the IoT device.

11. The method according to claim 9, further comprising transmitting, by the server, a request to record cancellation of user use registration as a transaction in the blockchain of the blockchain system to the blockchain system.

12. The method according to claim 8,
wherein the verifying comprises determining that the devices is not a validly usable device, when firmware information of the IoT device included in the search result information associated with the device information received from the blockchain system does not satisfy conditions of firmware information for the service use.

13. The method according to claim 12, further comprising transmitting, by the server, a firmware update request message to a client or the IoT device, when it is determined that the firmware information of the IoT device does not satisfy conditions of firmware information for the service use.

14. The method according to claim 8,
wherein, the verifying comprises determining that the device is not a validly usable device, when at least one of information indicating that the device has been hacked, information indicating that the device has been used illegally, and information indicating that there is an error in some or all of functions of the device is recorded in history information of the IoT device included in the search result information associated with the device information received from the blockchain system.

15. The method according to claim 8,
wherein the blockchain of the blockchain system is a permissioned blockchain, which requires prior permission for participation and sets authority for the blockchain for each participant.

16. The method according to claim 9,
wherein the blockchain comprises at least one block connected by hash chain, and
the blockchain system comprises at least one node, which verifies the validity of the transaction corresponding to the request to record and the block comprising at least the transaction based on a predefined consensus algorithm and then adds the block comprising the transaction to the blockchain.

17. A method for managing information of an IoT device performed by a device managing the information of the IoT device, comprising:
receiving device information including identification information of the IoT device associated with updated firmware;
retrieving the received device information in a blockchain of a blockchain system to receive search result information associated with the device information recorded as a transaction in the blockchain from the blockchain system; and
verifying whether the IoT device is a device registered as a validly usable device and/or whether the updated firmware associated with the IoT device is validly registered based on the received search result information.

18. The method according to claim 17, further comprising: transmitting a request for transmission of the updated firmware registered with the blockchain in relation to the IoT device in the blockchain system to the blockchain system, when the IoT device is verified as a device registered as a validly usable device and the updated firmware associated with the IoT device is verified as validly registered; and
receiving the firmware recorded as a transaction in the blockchain of the blockchain system.

19. The method according to claim 17, further comprising:
receiving the firmware from the blockchain system and then transmitting the received firmware to the IoT device;
receiving a message informing completion of installation of the firmware from the IoT device; and
transmitting a request to record firmware update completion information as a transaction in the blockchain of the blockchain system to the blockchain system.

20. The method according to claim 17,
wherein the blockchain of the blockchain system is a permissioned blockchain, which requires prior permission for participation and sets authority for the blockchain for each participant.

21. The method according to claim 19,
wherein the blockchain comprises at least one block connected by hash chain, and
the blockchain system comprises at least one node, which verifies the validity of the transaction corresponding to the request to record and the block comprising at least the transaction based on a predefined consensus algorithm and then adds the block comprising the transaction to the blockchain.

22. A device managing the information of an IoT device, comprising:
a memory; and
at least one processor connected to the memory,
wherein the at least one processor is configured to:
receive device information including identification information of the IoT device from the IoT device responding to a request for service use registration;
retrieve the received device information in a blockchain of a blockchain system to receive search result information associated with the device information recorded as a transaction in the blockchain from the blockchain system; and
verify whether the IoT device is a device registered as a validly usable device based on the received search result information.
